(19) United States
(12) Patent Application Publication
(10) Pub. No.: US 2015/0003904 A1
(43) Pub. Date: Jan. 1, 2015

(54) CAST SOCKET STRUCTURE, ASSEMBLIES INCLUDING THE SAME, AND METHODS OF MAKING AND USING THE SAME

(71) Applicant: GM Global Technology Operations LLC, Detroit, MI (US)

(72) Inventors: Robert N. Saje, Shelby Township, MI (US); Artur Wyszynski, Oxford, MI (US); Robert M. Kielbik, Chesterfield Township, MI (US)

(21) Appl. No.: 13/930,868

(22) Filed: Jun. 28, 2013

(51) Int. Cl. B62D 27/02; B62D 21/15

(52) U.S. Cl. CPC B62D 27/023; B62D 21/15
USPC 403/361

(57) ABSTRACT

A number of variations may include a product including a cast socket structure that may be used to join rails of a vehicle.

### TECHNICAL FIELD

The field to which the disclosure generally relates to includes cast socket structures, assemblies including the same, and methods of making and using the same.

### BACKGROUND

Vehicles may be equipped with one or more rail portions which may be joined together.

### SUMMARY OF ILLUSTRATIVE VARIATIONS

A number of variations may include a product including a cast socket structure that may be used to join rails of a vehicle.

Other illustrative variations within the scope of the invention will become apparent from the detailed description provided hereinafter. It should be understood that the detailed description and specific examples, while disclosing variations of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a perspective view of a product including a cast socket structure joining a first rail, which may be a crush can, and a second rail according to a number of variations.

FIG. 2 is a sectional view, with portions broken away of the product illustrated in FIG. 1.

FIG. 3 is an enlarged view of a portion of the product shown in FIG. 2.

FIG. 4 illustrates a vehicle, with portions broken away and portions removed, including a cast socket structure according

### DETAILED DESCRIPTION OF ILLUSTRATIVE VARIATIONS

The following description of the variations is merely illustrative in nature and is in no way intended to limit the scope of the invention, its application, or uses.

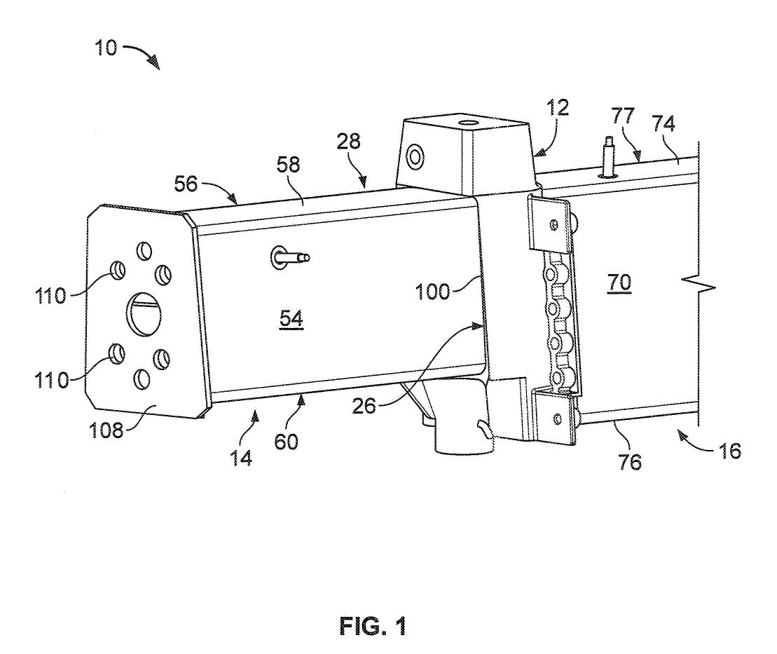

FIGS. 1-4 illustrate a product according to a number of variations. Referring now to FIG. 1, a number of variations may include a product 10 including a cast socket structure 12 which may be used to join a first rail 14, which may be a crush can, and a second rail 16.

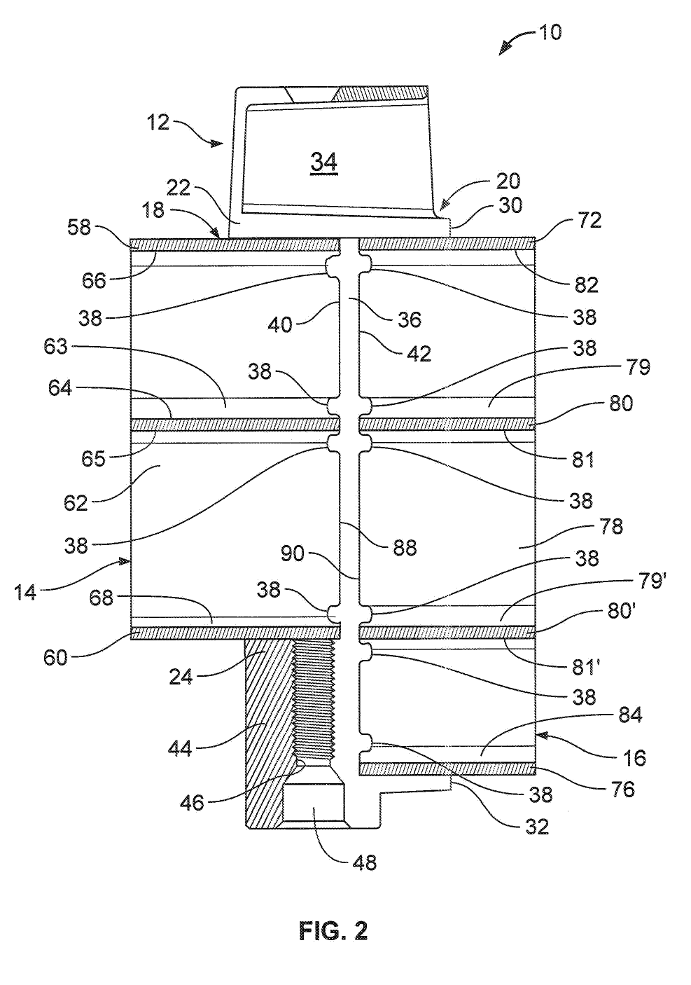

Referring now to FIGS. 1-2, in a number of variations, the cast socket structure 12 may be constructed and arranged to include a first socket portion defining a first socket for receiving a first rail 14, which may be a crush can of a vehicle. The cast socket structure 12 may also be constructed and arranged to provide a second socket portion 20 defining a second socket for receiving a second rail 16. As best seen in FIG. 1, the cast socket structure 12 may include a first side wall 26 and an opposite side wail 28. The cast socket structure 12 may include an inner wall face 34 from which a first lip 22 and a second lip 24 may extend. The first lip 22 and second lip 24 may define, at least in part, the first socket portion 18 and the first socket for receiving the first rail 14. The cast socket structure 12 may include a third lip 30 and a fourth lip 32 which may define, at least in part, the second socket portion 20 to define a second socket for receiving the second rail 16. The cast socket structure 12 may include an inner flange 16 which may extend from the inner wall face 30 in at least a number of variations. A plurality of projections 38 may extend from at least one of a first edge 40 or a second edge 42 of the inner flange 36. In a number of variations, the projections 38 may be in the form of beads. In a number of variations, the projections 38 may be a casted feature formed in the casting of the cast socket structure 12. The cast socket structure 12 may also include a trunk portion 44 having a threaded bore 46 formed therein for receiving a threaded bolt 48 which may be used to, at least partially, to secure the cradle or the first rail 14 in the cast socket structure 12.

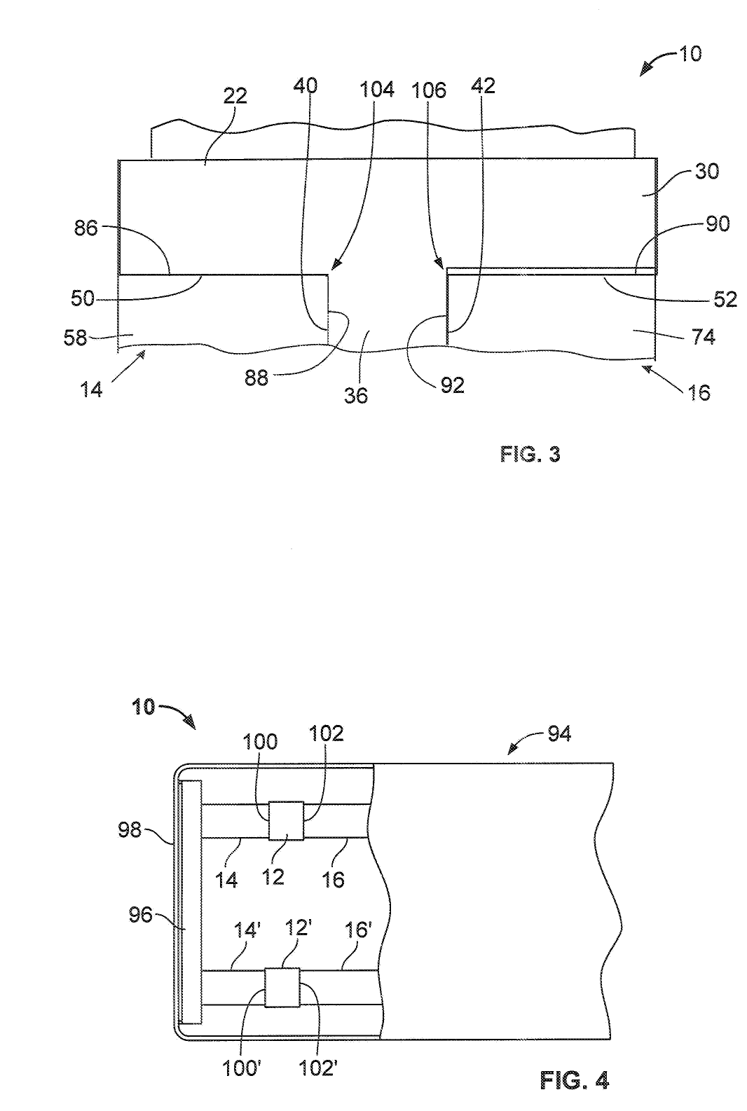

As best seen in FIG. 3, the cast socket structure 12 may be constructed and arranged so that the first lip 22 has a first inner bottom surface 50 and the third lip 30 has a second inner bottom surface 52. As is well-known in the art, corner portions of castings typically are formed with a fillet. In a number of variations of the invention, at least one of the first edge 40 of the inner flange 36 or the first inner bottom surface 50 of the first lip 22 are machined so that a first end face 88 of the first rail 14 may be butted-up against the inner flange 36 to provide a net section joint. Similarly, at least one of the second edge 42 of the inner flange 36 or the second inner bottom surface 52 may be machined so that a first end face 92 of the second rail 16 may be butted against the inner flange 36 with no tolerances or substantially no tolerances. In a number of variations, the cast socket structure 12 may include corner potions 104, 106 without fillets.

Referring now again to FIG. 1, the first rail 14 may include a first side wall 54 and an opposite second side wall 56, a top wail 58, and a bottom wall 60 which are connected together. In a number of variations, the first rail 14 may be an extrusion so that the first side wall 54, second side wall 56, top wall 58, and bottom wall 60 are one continuous, non-joined, piece of material. In a number of variations, the first rail 14 may be made from a material including aluminum.

Referring again to FIG. 2, in a number of variations, the first rail 14 may include a first inner face 62. At least a first rib 64 may extend inwardly from the first inner face 62. The first rib 64 may extend in an axial direction with respect to the elongated first rail 14. The top wall 58 may have an inner face 66 and the bottom wall 60 may have an inner face 68. When a first end face 88 of the first rail 14 is butted against the first edge 40 of the inner flange 36, a projection 38 may be positioned against or very near the inner face 66 of the top wall 58. Another projection may engage or be very near the edge 63 of the first rib 64 and another projection 38 may be against or near a second edge 65 of the first rib 64. Another projection 38 may be against or very near the inner face 68 of the bottom wall 60. The projections 38 may be constructed and arranged to prevent the first rail 14 from torqueing during impact and allows the first rail 14 to axially compress during the impact.

Referring again to FIG. 1, the second rail 16 may include a first side wall 70 and opposite second side wall 72, a top wall 74, and an opposite bottom wall 76. Referring again to FIG. 2, the second rail 16 may include an inner face 78 of a side wall. One or more ribs 80, 80′ may extend from the inner face 78. The ribs may extend in an axial direction along the elongated second rail 16. The second rail 16 may provide an inner face 82 of the top wall 72 and an inner face 84 of the bottom wall 76. In a number of variations, when a first end face 90 of the second rail 16 is butted against the second edge 42 of the inner flange 36 of the cast socket structure 12, a first projection 38 is positioned against or near the inner face 82 of the top wall 72. Another projection 38 may engage or be near a first edge 79 of a first rib 80 and another projection 38 may engage or be near a second edge 81 of a first rib 80. Similarly, another projection 38 may engage or be near a first edge 79′ of a second rib 80′ and another projection 38 may be against or near a second edge 81′ of the second rib 80′. Another projection may engage or be near the inner face 84 of the bottom wall 76 of the second rail 16.

Referring now to FIG. 4, a product 10 may include a vehicle 94 including a cast socket structure 12 joining a first rail 14 and a second rail 16. The cast socket structure 12 may be welded to the first rail 14 along edge 100 and the second rail 16 may also be welded to the cast socket structure 12 along edge 102. The cast socket structure 12 may be constructed and arranged so that when the first rail 14 and second rail 16 are abutted against the inner flange 36, the net sectioning produces edges 100 and 102 with zero clearance. The zero clearance associated with edges 100 and 102 results in an extremely reliable weld along edges 100 and 102 which are much stronger than welds along similar edges that have clearances .

In one variation a cross vehicle structure such as a rail 96 may be attached to the first rail 14 which may have an end plate 108 having a plurality of through-holes 110 formed therein to facilitate attachment of the cross vehicle structure 96 (for example, as illustrated in FIG. 1). A body panel(s) or other covering(s) 96 may be secured to the cross vehicle structure 96 or to the first rail 14.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product comprising: a cast socket structure having an inner face and an inner flange extending inwardly from the inner face, a first lip extending from the inner face and connected to the inner flange, a second lip extending from the inner face and connected to the inner flange, the first lip and the second lip defining, at least in part, a first socket for receiving a first rail of a vehicle, a third lip extending from the inner face and connected to the inner flange and a fourth lip extending from the inner face and connected to the inner flange, the third lip and fourth lip defining, at least in part, a second socket for receiving a second rail of a vehicle, the inner flange having a first edge and an opposite second edge, each of the first lip and second lip having an inner face each meeting with the first edge of the inner flange, and each of the third lip and the fourth lip having an inner face meeting with the second edge of the inner flange, and wherein at least one of the inner face of the first lip, inner face of the second lip, first edge of the inner flange, second edge of the inner flange, inner face of the third lip or inner face of the fourth lip are machined to allow at least one of a first rail or second rail to be butted against the inner flange without tolerances or with substantially no tolerances.

Variation 2 may include a product as set forth in Variation 1 wherein the cast socket structure is constructed and arranged so that there is no fillet connected to the inner flange.

Variation 3 may include a product as set forth in any of Variations 1-2 wherein the inner flange further comprises a plurality of projections extending from at least one of the first side or second side of the inner flange.

Variation 4 may include a product as set forth in any of Variations 1-3 wherein the cast socket structure comprises a trunk portion having a threaded bore through-hole communicating with the first socket.

Variation 5 may include a product as set forth in any of Variations 1-5 further comprising a first rail received in the first socket of the cast socket structure.

Variation 6 may include a product as set forth in any of Variations 1-5 further comprising a second rail received in the second socket of the cast socket structure.

Variation 7 may include a product as set forth in any of Variations 1-6 further comprising a first rail received in the first socket of the cast socket structure, the first rail including at least a first rib, the first rib having a first side and an opposite second side, and wherein one of the plurality of projections engages the first side of the first rib and another projection engages a second side of the second rib of the first rail.

Variation 8 may include a product as set forth in any of Variations 1-7 wherein the first rail includes a first side wall, an opposite second side wall, a top wall, and a bottom wall, and wherein one of the plurality of projections engages an inner face of the top wall and wherein one of the projections engages an inner face of the bottom wall.

Variation 9 may include a product as set forth in any of Variations 1-8, further comprising a first rail received in the first socket of the cast socket structure, and further comprising a threaded bolt received in the threaded bore through-hole and engaging the first rail.

Variation 10 may include a product as set forth in any of Variations 1-9 wherein the second rail includes an inner face and a first rib extending from the inner face, the first rib having a first edge and an opposite second edge and wherein one of the plurality of projections engages the first edge of the first rib and wherein another of the plurality of projections engages the second edge of the first rib of the second rail.

Variation 11 may include a product as set forth in Variation 10 wherein the second rail further comprises a second rib extending from the inner face, the second rib having a first edge and an opposite second edge and wherein one of the plurality of projections engages the first edge and another of the plurality of projections engages the second edge of the second rib of the second rail.

Variation 12 may include a product as set forth in any of Variations 1-11 wherein the second rail includes a first side wall and an opposite second side wall, a top wall and a bottom wall, and wherein one of the plurality of projections engages an inner face of the top wall and one of the projections engages an inner face of the bottom wall.

The above description of select variations within the scope of the invention is merely illustrative in nature and, thus, variations or variants thereof are not to be regarded as a departure from the spirit and scope of the invention.

What is claimed is:

1. A product comprising:
a cast socket structure having an inner face and an inner flange extending inwardly from the inner face, a first lip extending from the inner face and connected to the inner flange, a second lip extending from the inner face and connected to the inner flange, the first lip and the second lip defining, at least in part, a first socket for receiving a first rail of a vehicle, a third lip extending from the inner face and connected to the inner flange and a fourth lip extending from the inner face and connected to the inner flange, the third lip and fourth lip defining, at least in part, a second socket for receiving a second rail of a vehicle, the inner flange having a first edge and an opposite second edge, each of the first lip and second lip having an inner face each meeting with the first edge of the inner flange, and each of the third lip and the fourth lip having an inner face meeting with the second edge of the inner flange, and wherein at least one of the inner face of the first lip, inner face of the second lip, first edge of the inner flange, second edge of the inner flange, inner face of the third lip or inner face of the fourth lip are machined to allow at least one of a first rail or second rail to be butted against the inner flange without tolerances or with substantially no tolerances.

2. A product as set forth in claim 1 wherein the cast socket structure is constructed and arranged so that there is no fillet connected to the inner flange.

3. A product as set forth in claim 1 wherein the inner flange further comprises a plurality of projections extending from at least one of the first side or second side of the inner flange.

4. A product as set forth in claim 1 wherein the cast socket structure comprises a trunk portion having a threaded bore through-hole communicating with the first socket.

5. A product as set forth in claim 1 further comprising a first rail received in the first socket of the cast socket structure.

6. A product as set forth in claim 1 further comprising a second rail received in the second socket of the cast socket structure.

7. A product as set forth in claim 3 further comprising a first rail received in the first socket of the cast socket structure, the first rail including at least a first rib, the first rib having a first side and an opposite second side, and wherein one of the plurality of projections engages the first side of the first rib and another projection engages a second side of the second rib of the first rail.

8. A product as set forth in claim 7 wherein the first rail includes a first side wall, an opposite second side wall, a top wall, and a bottom wall, and wherein one of the plurality of projections engages an inner face of the top wall and wherein one of the projections engages an inner face of the bottom wall.

9. A product as set forth in claim 4, further comprising a first rail received in the first socket of the cast socket structure, and further comprising a threaded bolt received in the threaded bore through-hole and engaging the first rail.

10. A product as set forth in claim 6 wherein the second rail includes an inner face and a first rib extending from the inner face, the first rib having a first edge and an opposite second edge and wherein one of the plurality of projections engages the first edge of the first rib and wherein another of the plurality of projections engages the second edge of the first rib of the second rail.

11. A product as set forth in claim 10 wherein the second rail further comprises a second rib extending from the inner face, the second rib having a first edge and an opposite second edge and wherein one of the plurality of projections engages the first edge and another of the plurality of projections engages the second edge of the second rib of the second rail.

12. A product as set forth in claim 6 wherein the second rail includes a first side wall and an opposite second side wall, a top wall and a bottom wall, and wherein one of the plurality of projections engages an inner face of the top wall and one of the projections engages an inner face of the bottom wall.
